(19) United States
(12) Patent Application Publication
(10) Pub. No.: US 2005/0139686 A1
(43) Pub. Date: Jun. 30, 2005

(54) Identification device

(75) Inventors: Jonathon Charles Helmer, Geelong West Victoria (AU); Richard James Neil Helmer, Newton Victoria (AU)

Correspondence Address: MARSH, FISCHMANN & BREYFOGLE LLP, 3151 SOUTH VAUGHN WAY, SUITE 411, AURORA, CO, 80014, US

(73) Assignee: Commonwealth Scientific and Industrial Research Organisation, Australian Capital Territory (AU)

(21) Appl. No.: 10/501,198

(22) PCT Filed: Jan. 9, 2003
(86) PCT No.: PCT/AU03/00018

(30) Foreign Application Priority Data
Jan. 9, 2002 (AU) PR 9865

(51) Int. Cl. G06K 19/00; G06K 19/06

(52) U.S. Cl. 235/494; 235/487

(57) ABSTRACT

An identifier comprising at least two machine readable components (62, 64) wherein at least one of the components (64) is capable of being changed from an original value to a modified value in response to a stimulus. In particular it provides for identifiers having codes such as bar codes or pictographic codes, with part of the codes being formed from a material which changes colour in response to a stimulus such as heat, atmosphere or flow of an electric current such that the value of the code as read by a machine may be changed to indicate that the identifier has been exposed to the stimulus. Also disclosed in an identifier formed by applying a light coloured material over a dark coloured surface such that gaps in the light coloured material form a machine readable code.

### FIELD OF THE INVENTION

The present invention relates to an identification system. More particularly, it relates to a system of identification labelling wherein the information contained in the identifier or label may be updated.

### BACKGROUND OF THE INVENTION

In this specification, where a document, act or item of knowledge is referred to or discussed, this reference or discussion is not an admission that the document, act or item of knowledge or any combination thereof was at the priority date:
(i) part of common general knowledge; or
(ii) known to be relevant to an attempt to solve any problem with which this specification is concerned.

A wide range of items have information material attached to or in association with them. Such information would commonly include identification of the goods and manufacturing, transport, storage and/or price. This information may be in many forms including alpha-numeric characters, symbols, optical codes (such as bar codes) or combinations of forms.

It is sometimes desirable to indicate information about the history of the items. Examples include indicating whether the item has been exposed to high levels of moisture, or whether a sealed container has been opened. Such indication can be given by inclusion on the labelling of a chemically sensitive patch which changes colour on exposure to water or oxygen. Only a limited range of information can be displayed in this way, and this information can only be read by a limited number of methods.

By way of example, EP 0,282,178, EP 1,205743, U.S. Pat. No. 5,087,659, U.S. Pat. No. 4,179,397, U.S. Pat. No. 5,679,442, U.S. Pat. No. 5,518,927 and U.S. Pat. No. 4,756,758 all disclose methods of identifying whether an item has been sterilised by means of a printed region which undergoes an irreversible colour change when exposed to heat. The colour change can be discerned by eye and in some cases by a reading machine capable of sensing change in colour.

U.S. Pat. No. 6,378,906 discloses a colour patch which changes colour gradually over multiple sterilization cycles so that the number of such cycles can be estimated approximately by comparing the shade of the colour with a standard scale.

U.S. Pat. No. 5,058,088 and U.S. Pat. No. 5,997,927 describe labels which gradually change colour with time such that the elapsed time can be estimated approximately by comparing the shade of the colour with a standard scale.

EP 0 250 217 and EP 0 699 304 both describe food labels including bar codes which are initially machine readable, but which are rendered unreadable by machine if the food becomes spoiled by specific means (frozen food de-frosted and toxins detected, respectively).

All of the above-described prior art relates to methods by which simple changes occur which are detectable by the human eye, by specially configured reading machines or by rendering a label unreadable by a machine.

### OBJECT OF THE INVENTION

It is an object of the present invention to provide an alternative type of modifiable identification.

### SUMMARY OF THE INVENTION

The present invention provides in one embodiment an identifier comprising at least two machine readable components wherein at least one of the said components is capable of being changed from an, original value to a modified value in response to a stimulus. According to another embodiment of the invention there is provided an identifier comprising at least two machine readable components wherein at least one of the said components is capable of being changed from one colour to another colour in response to a stimulus. According to a further embodiment of the invention there is provided an identifier comprising a bar code or pictographic code having at least two machine readable components wherein at least one of the said components is capable of being changed from an original value to a modified value in response to a stimulus wherein both the original value and the modified value are machine readable.

The present invention provides in another embodiment a package having an identifier according to the invention as described herein.

The present invention provides in another embodiment an item having an identifier according to the invention as described herein.

In its preferred aspects the present invention uses substances which are capable of changing colour when exposed to a stimulus such as an electric current, temperature change, exposure to light (for example to a certain threshold of intensity and/or duration of light which may be of a broad range or a narrow range of wavelengths), exposure to electro-magnetic radiation, moisture change, exposure to certain chemicals exposure to pressure, exposure to certain gases or vapours, exposure to certain liquids, emulsions or slurries, exposure to certain solids (e.g. through contact and/or abrasion) or passage of a certain period of time. Such a stimulus will be referred to as an ‘activating event’ in this specification. The substances will usually be in the form of, or capable of being used as, inks or transferable films. One or more of these substances may be used, usually in combination with a conventional marking material (e.g. black or coloured ink) which will be referred to as ‘permanent material’ in this specification. These are applied to a surface to form an identification mark or marks. Typically the identification mark will be in the form of a bar code, one or more graphic symbols, a pictographic code, and/or an alphanumeric designation which may be machine readable. At least some components of the mark(s) will include areas formed from the colour changing substances. Conveniently there will also be areas of such components which are formed from permanent material. Therefore, when first formed such a component of the mark will be read in a particular way by the eye or by a reading machine, but if an activating event has occurred the component of the mark will change in its appearance. If the code is then read by eye or by machine, an indication will be given that at some time in its history the mark has been exposed to the environment which resulted in the activating event. The change in the code may indicate either a desirable or an undesirable activating event. For example indication of exposure to high temperature may be used to advise that the identification mark has been in a sterilising environment, or to warn that it has been in an environment which may have caused thermal degradation.

For example, if the code includes alphabetic characters, it is possible for a character to be printed from permanent material to form an ‘I’ and to also incorporate a colour changing substance which is initially not detected but which after an activating event changes colour and adds to the detected character so that it becomes a ‘P’. It would be possible to add regions of one or more additional colour changing substances such that a more extreme environment would result in an additional portion changing colour so that the character would then be detected as a ‘B’. Conversely, colour changing substances which cease to be detectable after exposure to an activating event could be used such that the order of events would be reversed, that is ‘B’ could change to ‘P’ which could change to ‘I’. A combination of colour changing substances, one or more of which become detectable after exposure to an activating event, and one or more others of which cease to be detectable after an activating event, permit a wider range of character changes to be detected.

Bar codes have lines of various width of dark colour interspersed with lines of various width of light colour (usually the background colour of the label on which the bar code is printed). The relative widths of the dark and light lines are adjusted to encode numeric information. If some lines (or part of the width of some lines) are formed from colour changing substances, then exposure to an activating event will result in the number corresponding to the detected code changing.

In one embodiment of the invention, the colour changing substance is one which is capable of changing colour in response to an electric current. One example of such a substance is ‘E Ink’ which is described in Scientific American November 2001 at pages 38 to 43. If such a substance is used the colour change may be induced either directly or indirectly.

A directly induced colour change might be produced by applying an electric current to the electrically sensitive material, for example by an operator briefly attaching an electric cell to contacts electrically connected to an area of the character so that its appearance is changed to indicate that the item has been checked or passed through a storage or control stage. As a non-limiting example, such an arrangement might be useful in recording the manufacturing or storage history of an item.

The use of the term ‘indirectly induced colour change’ is intended to signify that some other activating event results in the flow of an electric current which causes a change of colour of the colour changing substance. Typically in such an arrangement, the electrically sensitive colour changing substance would form part of an electric circuit which would also include an electric cell and a sensor capable of functioning as an electric switch. Normally such a switch would be in the open position and no current would flow and hence no colour change would occur. If the sensor were to detect a relevant change in its environment, it would cause the switch to go to the closed position, an electric current would flow and the colour change would occur. Depending on the purpose which the change is to indicate, the colour changing substance might be one in which the colour change is only maintained while the current is flowing, or it might remain changed unless a reversing current is applied, or the change might be substantially permanent.

Non-limiting examples of possible uses of embodiments of the invention incorporating indirectly induced colour changing substances include:
Arrangements incorporating temperature or humidity sensors such that the appearance of a character is changed if the sensor has been exposed to inappropriate storage conditions, or to indicate that the item to which it is attached has been sterilised.
Chemical sensors (e.g. for ammonia) inside a food package connected to an external label to indicate that the contents have deteriorated. Such information might be automatically read by a scanner at a supermarket check-out, or visually noted by the ultimate consumer prior to use.
Chemical sensors inside a wine bottle connected to an external label capable of indicating that either the wine is not fully matured, or that it has deteriorated.
An electric circuit around a package (e.g. printed using conductive ink) connected to the electric cell and colour changing substance such that the appearance of a character changes if the box has been tampered with so as to cause a break in the electric circuit.

Another form of the invention is particularly useful when an identifier is to be applied to a surface of dark colour. A common example is when bar codes are printed onto the surface of containers which use low brightness paper-board (such as unbleached paper-board). Such containers are commonly used for shipping goods and in wholesale operations. It is often required to apply identifiers to such containers but it is also desirable to keep printing costs to a minimum and aesthetics are often not important. However, as the container surface is of low brightness, there may be difficulty in ensuring that there is a sufficient colour difference between the background (the surface of the container) and the foreground (the printed portion of the identifier) so that the value of a code may be scanned adequately. Conventionally, this problem has been overcome by one of two means. The first means has been to print a region of light colour to form a background and then to print dark bar codes or other identification marks over this region of light colour. This method is effective but requires two colour printing which is much more expensive than one colour printing. The second means is to use a container with a surface made from brighter material than would otherwise be required. This increases the cost of manufacture of the container and excludes the use in the paper-board of dark coloured pulps made from low cost processes (such as ‘green liquor’ and ‘carbonate’ semi-chemical pulping processes).

In one form of the present invention identifiers may be placed on a dark surface by covering the parts of the identifier which constitute its background with a light colour material and utilising some or all of the regions which are not so covered as the foreground. Preferably the light coloured material is placed by printing or by application of a film.

In a preferred form of the invention, the container surface is formed from low brightness paper or paper-board and the light coloured material is selected so that a reading machine or scanner is capable of distinguishing between the foreground and back ground. More preferably the light coloured material is selected so that a reading machine or scanner is capable distinguishing the foreground and background as being in different binary states. Preferably the identifier is in the form of a binary code such as a 1-dimensional or 2-dimensional bar code. In another preferred form of the invention the identifier includes at least one region formed from at least one colour changing material which may be caused to change colour and so change the information displayed on or readable from the identifier.

Many other uses of the invention will be apparent to one skilled in the art.

Usefully, the invention may be incorporated. into a bar code or other labelling system such that one part of the code contained thereon is of a permanent material and includes product identification information equivalent to that contained on conventional labels, and another part of the code includes areas of colour-changing substance which are capable of changing to indicate the storage history, state of contents or other variable information about the associated product.

In one form, the invention relies upon the change of a material from one state to another state. The two states can be differentiated by a digital scanning device. Conveniently, the material is incorporated into a structure or code that is readable by a digital device. The material is selected so that the change in the state of the material is capable of causing the structure or code to change from one readable form or value to another readable form or value.

### DESCRIPTION OF THE DRAWINGS

The invention will now be further explained by means of non-limiting examples and illustrated by reference to the accompanying drawings in which:

FIG. 1 is a view of the EAN 8 format one-dimensional bar code.

FIG. 2 is a view of one digit of an EAN 8 Type C code changing value.

FIG. 3 is a view of an EAN 8 Type C code changing value.

FIG. 4a is a view of a 2-dimensional bar code.

FIG. 4b is a view of an 11 digit 1-dimensional bar code.

FIG. 5 is another view of an 8 digit bar code changing value.

FIG. 6 is a schematic view of an identification code changing value as it is exposed to three different environments.

FIG. 7 is a schematic view of an identification code changing value as it is exposed to multiple different environments.

FIG. 8 is a schematic of a bar code capable of being updated by change in flow of electric current.

FIG. 9 is a schematic of an identification code capable of being updated by an external power source.

FIG. 10 is a schematic of a bar code capable of being updated by change in flow of an electric current.

FIG. 11 is a view of a bar code formed on a dark surface by one-colour printing.

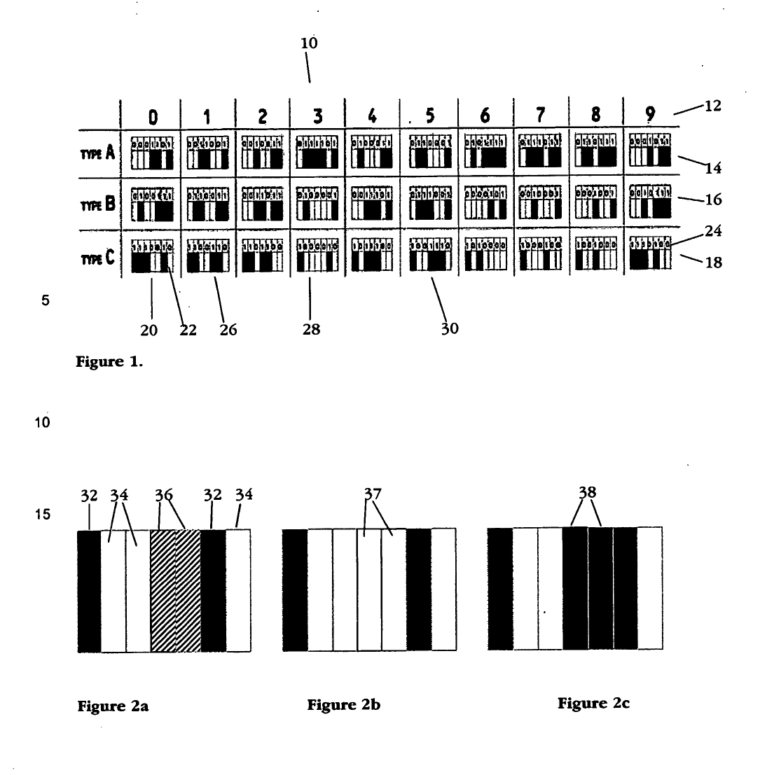

In one form, the invention may be applied to one dimensional barcodes such as those conforming to an EAN 8 format as shown in FIG. 1. The code format (10) represents the digits 0-9 (12) by any one of three types of code which are designated Type A (14), Type B (16) and Type C (18). Within a type of code (e.g. Type C for the digit 0 (20)) each digit is represented by a series of seven bars (22). Each one of the bars may be of various colours such that a reading machine or scanner (not shown) will interpret each bar as being of one or other of the binary states. These binary states are conventionally represented as ‘0’ or ‘1’and indicated (24) above each bar 22 on the code format 10, but not usually included with bar codes used on labels etc. Bar codes are commonly in the form of black bars (representing binary state ‘1’) on a white background (representing binary state ‘2’). However a wide range of colours may be used provided that the scanner is capable of distinguishing the colour which represents binary state 1 (the ‘foreground’ colour) from the colour which represents binary state 0 (the ‘background’ colour). Therefore not all of the foreground bars need be of the same colour provided that the scanner reads them as having the same binary value of 1. Similarly not all of the background bars need be of the same colour provided that the scanner reads them as having the same binary value of 0. Therefore, with suitable choice of materials, the permanent part of the bar code could be, for example, black and white and the colour changing part of the code might be dark blue or pale yellow in one of its states. This ability to mix colours in either of the binary states permits the use of a wide range of colour-changing materials. In some cases it may also be used to provide additional information to a human observer. The colour combinations which result in satisfactory, machine readable bar-codes are well known to those skilled in the art and are documented.

The EAN format Type C has a number of characters which contain similar elements within a prescribed format, e.g. 0, 1, 3, 5 (reference numbers 20, 26, 28, 30 in FIG. 1). It is possible to change the code representing certain of these digits to the code representing certain others of these digits through a change of binary state of some of the bars using only a single colour change substance. (Type B and Type C of EAN 8, and various other bar code formats also have characters which may be changed in this way).

If more than one colour changing substance is employed, more complex changes to values may be made.

An example of a character change within a prescribed format and Type (EAN/UPC Type C) is shown in FIG. 2. FIG. 2a shows the bar code as originally printed wherein some bars 32 are in a foreground colour, other bars 34 are in a background colour and the remaining bars 36 are of a colour changing material which may appear as either a foreground or a background colour. FIG. 2b shows the bar code wherein the colour-changing material is in the state where it appears as a background colour, and the code would be read as a ‘3’. FIG. 2b shows the same bar code after the colour-changing material has responded to a stimulus and changed to a state where it appears as a foreground colour, and the code would now be read as a ‘5’.

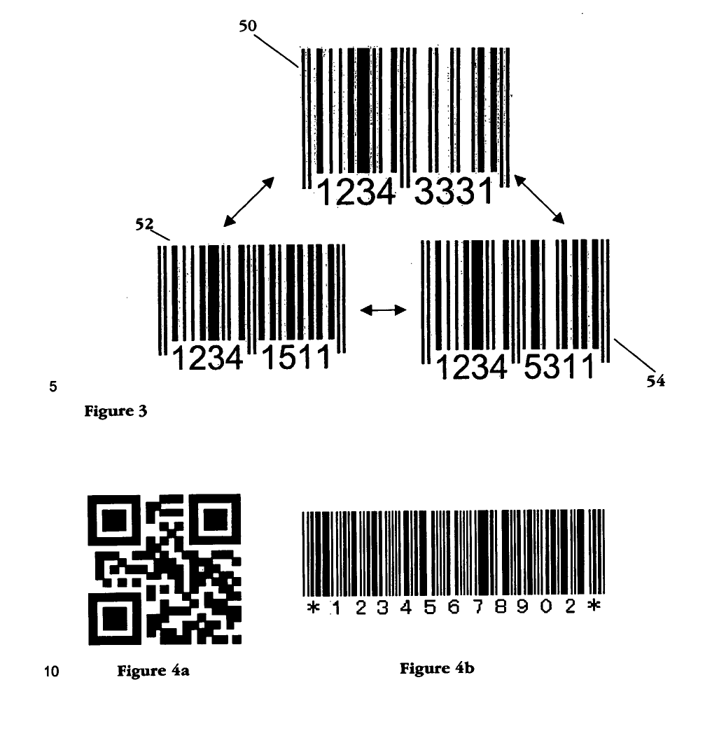

FIG. 3 shows an example wherein a bar code is printed incorporating more than one colour-changing material. The code is printed in such a manner that in response to different stimuli or combinations of stimuli changes in the states of the colour-changing materials may occur such that the code will be read as ‘1234 3331’ (50), ‘1234 1511’ (52) or ‘1234 5311’ (54). The changes may be reversible or irreversible. Alternatively, by suitable combinations of colour changing substances, some of the changes could be reversible and others could be irreversible.

Many code systems contain a check digit to reduce the error of an incorrectly scanned code being recorded. In the example shown in FIG. 3, the last digit is the check digit.

In very simple forms, the value of the check digit may be set equal to the sum of the values of the other digits (if this value is greater than 9, the process of summing digits is repeated as many times as necessary until a single digit result is obtained). If the value obtained by repeat summing of the digits does not equal the value of the check digit an error signal can be generated. This error signal may be to indicate that the code was not recorded.

Many code systems use other methods of calculating the value of the check digit (this value is also known as the ‘checksum’). For example, according to information provided by The Barcode Software Center of 1113 Hull Terrace, Evanston Ill., 60202 USA for EAN 13 codes wherein there are 12 useable digits and a 13^{th} digit which is used as a check digit, the checksum is a Modulo 10 calculation which may be calculated by the following steps:
1. Add the values of the digits in the even-numbered positions: 2, 4, 6, etc.
2. Multiply this result by 3.
3. Add the values of the digits in the odd-numbered positions: 1, 3, 5, etc.
4. Sum the results of steps 2 and 3.
5. The check character is the smallest number which, when added to the result in step 4, produces a multiple of 10.

### EXAMPLE

### Assume the Barcode Data=001234567890

1. 0+2+4+6+8+0=20
2. 20*3=60
3. 0+1 +3+5+7+9=25
4. 60+25=85
5. 85+X=90 (nearest equal or higher multiple of 10), therefore X=5 which is the checksum.

Depending on the code format employed, if it is required that the check digit is unchanged and remains satisfied, there may be multiple possible changes to the number represented by the bar code:

For example, in the following situation:
1. EAN 8 code format Type C is used (representing a number of 8 digits)
2. The first four digits are held fixed
3. The check digit is the 8^{th} digit (standard for EAN 8) and its value does not change.
4. The 5^{th}, 6^{th} and 7^{th} digits include bars formed from colour-changing material
5. For the 5^{th} 6^{th} and 7^{th} digits only the values 0, 1, 3 and 5 are used (because, as noted above, simple use of colour changing material can be employed to produce changes within this set)
6. The value of the check digit is 1:

The 8 digit code can take any of the following values and still satisfy the check digit: 1234 3331, 1234 1351, 1234 5311, 1234 1511,1234 0101, 1234 5151. Additional values which still satisfy the check digit may be obtained by transposing the the 5^{th}, 6^{th} and 7^{th} digits.

If it is not necessary to satisfy the check digit, the 5^{th}, 6^{th} and 7^{th} digits can take any readable value. Furthermore, codes may be used in which one or more colour change materials are incorporated into the check digit such that its value is capable of changing in response to a stimulus. In such case a wider change of values of the 5^{th}, 6^{th} and 7^{th} digits for either cases where the check digit is to be satisfied, or for cases where the check digit is not satisfied.

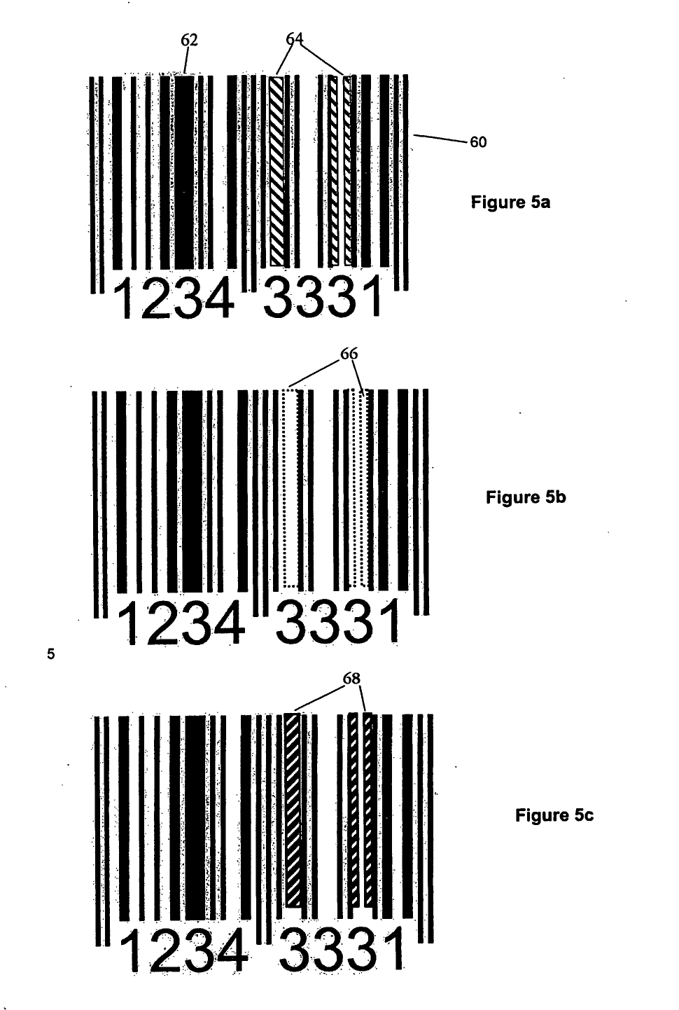

It will be apparent to one skilled in the art that the techniques described herein with respect to an eight digit code can also be applied to one-dimensional codes containing other numbers of digits, to two-dimensional codes, and to three-dimensional codes. FIG. 4 shows examples of such codes, wherein FIG. 4a is an example of a two-dimensional bar code and FIG. 4b is an example of an 11 digit one-dimensional bar code. Three-dimensional codes may be formed by a number of means including: different coloured regions distributed in a three-dimensional matrix, layers of different colours of translucent two dimensional code, holographs, liquid crystals, or two dimensional codes also having non-uniform thickness or optical thickness in the third dimension. Different types of scanners may be required depending on the means used to form the three-dimensional code.

FIG. 5a shows a functionally reversible bar code 60 conforming to EAN 8 Type C which may be constructed using conventional print technology. A permanent material is used to print most of the foreground 62 of the bar code. A portion 64 of the bar code is printed in a colour-changing material (indicated by light cross-hatching in FIG. 5a to show its position). Depending on the temperature of the bar code, the colour changing material, which may be a thermochromic ink, will appear to a scanner as either a background colour or as a foreground colour. The label shown in FIG. 5a was attached to a soft-drink bottle sitting at room temperature (about 23° C.). At this temperature the bars printed in colour changing material. adopted a state in which a scanner interpreted them as background colour 66 (indicated in FIG. 5b by a dotted perimeter of the bars) and interpreted the code as ‘1234 3331’. The soft-drink bottle was then placed in a refrigerator until the temperature of the bar code was about 9° C. At this temperature the bars printed in colour changing material adopted a state in which a scanner interpreted them as foreground colour 68 (indicated in FIG. 5c by heavy cross-hatching) and interpreted the code as ‘1234 5311’. The code value was still interpreted as ‘1234 5311’ when the soft-drink bottle was returned to a room temperature environment and handled in a manner similar to that which might be expected to occur when a bottle is removed from a refrigerator and taken to a shop counter or check-out station. It will be apparent that colour changing materials which change their appearance at different temperatures may be used depending on the application. Further, in the example shown in FIG. 5a-c, the Arabic numerals which appear below the bar code did not change to reflect the change in value of the bar code, but by appropriate use of colour changing materials such a change in the Arabic numerals may be provided. It will also be apparent that a similar method may be employed for goods which may be sold in either a heated or an un-heated condition by using a colour changing material which changes temperature at a temperature somewhat above ambient. A code which changes with temperature may be useful in many applications, for example, a higher price is charged for food or drink if it is refrigerated or heated than if it is sold at ambient temperature, containers of intravenous drip material may be coded so that they may be scanned to give different values depending on their temperature.

It will be apparent that an identifier similar to that illustrated in FIGS. 5a-c may employ a colour changing material which exhibits a permanent change of colour in response to a stimulus (by which is meant a change is sustained for a useful period after the stimulus is removed). In this case the value of the code will provide information about past events in history of the identifier. For example, if a bar code incorporates colour change material which exhibits a permanent change of colour when exposed to suitably high or low temperatures, the value read by a scanner may be used to reveal whether the bar code has in the past been exposed to sterilisation or to freezing respectively.

By combination of two or more colour changing materials in an identifier such as a bar code, more complex information about the history of the bar code can be displayed. For example FIG. 4a shows a scheme which may be used to track the thermal history of food items to which an identifier is attached. Environments 1, 2 and 3 are different temperature ranges. States 1, 2 and 3 are different appearances of certain of the colour changing materials. Codes 1, 2 and 3 are different values as would be read from the identifier by a scanner.

If a sample of fresh food is initially in Environment 1 which is at ambient temperature, the identifier will be in its State 1 and the value of the code will be ‘A’. If this food is then placed in Environment 3 which is a chilled cabinet at about 5° C., one of the colour change materials will reversibly change colour such that the scanned value of the code will be ‘C’.

Alternatively, if the sample of fresh food is moved from Environment 1 to Environment 2 which is a freezer at about −15° C., a different colour change material will be activated by the low temperature but a colour change will not occur (for example the colour change material may consist of two aqueous components which are capable of interacting but which are separated because one of them is initially encapsulated, freezing will rupture at least some of the capsules, but as the components are now in a frozen state they will still not interact). Therefore the scanned value of the code in Environment 2 will remain ‘A’. If the food is then defrosted, the two components will interact to cause a permanent colour change. If the defrosted food is placed in Environment 3 the combination of reversible and permanent colour changes will be such that the scanned value of the code will be ‘B’ which will indicate that the food has previously been frozen and defrosted, and is now chilled.

It will be apparent to the person skilled in the art that much more complex combinations are possible as indicated in FIG. 5. The number of changes which may be tracked is limited only by the number of available binary locations within given code format bars on a one-dimensional bar code (or available locations on a two dimensional or three-dimensional bar code) and the availability of suitable colour change materials responding to different stimuli. In a particular situation, such as shown in FIG. 5 a combination of reversible and permanent changes may be used, stimuli may result in a colour change or merely result in an activation to change when a subsequent stimulus is experienced. Further the nature of the stimuli may be varied and may include any one or more stimuli from the following non-exclusive list: temperature, pressure, physical force, humidity, electromagnetic radiation of various types, contact with chemicals, passage of electric current. Accordingly, the value scanned from the code may give information about the stimuli to which it has been exposed, and may even give information about the order in which it was exposed to certain of these stimuli.

In the previously described forms of the invention, most of the changes in code value described resulted from a colour-changing material responding directly to a stimulus, for example a thermochromic ink changing colour as a result of being placed in an environment at a particular temperature. A further wide range of applications is possible where the change in the colour-changing material is indirectly induced. For example a sensor which is separate from the colour changing material may be employed to detect an environmental change thus causing a stimulus to be transmitted or applied to the colour changing substance.

Conveniently, the means of transmission of the stimulus will often be an electric current or an electric potential. In such cases the colour changing material may be one which responds to the electric signal (for example ‘E Ink’ as described above) or it may be one which responds indirectly (for example, an electric current may cause the heating of electrically resistive element through which it flows and thus causing a change in colour of a thermo-chromic ink with which at least part of the electrically resistive element has been coated).

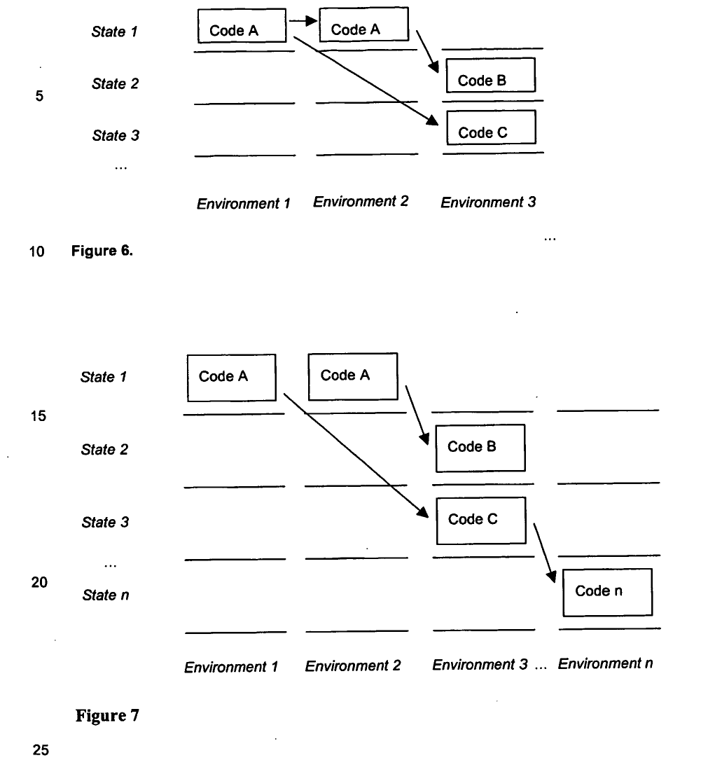

A circuit with an electronic code system comprising the elements: power source, circuit and sensor, and code label or tag is shown in FIG. 6. An identifier according to the invention 70 includes a code pattern 72 that is machine readable. Part of the code pattern 74 (indicated by solid bars in FIG. 6) may conveniently be printed by means of conventional print technologies (e.g. lithography, electrophotography, ink jet etc) using conventional permanent coloured materials (e.g. toner, lithographic ink, etc). A second part of the code pattern 76 is(indicated by cross-hatched bars in FIG. 6) includes a colour changing material which may be an electronically activated or electrochromic ink (e.g. E-ink®) or a thermo-chromic material which at least partly coats an electrically resistive material. A power source 78 is provided which may include one or more of an electrical battery (including a primary cell or a secondary cell), a photo-voltaic device, a piezo-electric device, or a capacitor (any of which may be formed by printing). A switch 80 is also provided and the power source 78, the switch 80 and the second part of the code pattern 76 are connected to form an electrical circuit by means of conductive elements 82 which may conveniently be printed. The switch 80 is normally in an open position and interacts with a sensor 84 in such a way that if the sensor 84 responds to a stimulus the switch is caused to close. Closing of the switch permits an electric current to flow through the second part of the code pattern 76 and the colour changing material is caused to change its colour. As a result of the change in colour the scanned value of the code is changed.

In the example illustrated in FIG. 8 there are shown three distinct bars of colour change material 76 which are positioned such that when they are caused to change colour the scanned value of the code will change. As shown in FIG. 8, the said three bars are all form part of the same electrical circuit and are all activated by the same stimulus. It will be apparent that the bars could be individually activated whereby either a single power source or a plurality of power sources are arranged to form two or more electrical circuits wherein at least two of such circuits contains a separate switch which interacts with a separate sensor, and the circuits include different bars or sets of bars of colour changing material. Usefully the separate sensors will respond to different stimuli so that depending on the environment(s) to which the sensors have been exposed various different values of the code may be scanned. It will be apparent that certain bars of colour change material could form part of two or more different circuits so that certain bars could be caused to change colour by more than one stimuli.

In the form of the invention shown in FIG. 8 it is usually desirable to have the switch 80 initially in the open position, as this will increase the period for which power is available from the power source 78. However, in some circumstances it may be necessary or preferable to have the switch 80 initially closed. In this case the electric current will only flow at a sufficient rate to maintain the colour change material in an activated state until the electrical potential of the power source falls below some limiting value. In such a case a change in the scanned value of the code may be the consequence of prolonged flow of electric current or of the sensor 84 responding to a stimulus. This may be useful in indicating, for example, that a substance with which the identifier 70 is associated is no longer fit for use because it has been stored for too long or because it has been exposed to an adverse stimulus (e.g. high humidity). It will be apparent that if the sensor 84 and switch 80 are omitted from the identifier 70 (or the switch is moved to the closed position by some initiating action such as when the identifier is attached to goods), a change in the scanned value of the code will indicate that some period of time has passed since the electric circuit was formed. Thus, in this form, the identifier may be used as an approximate timer. For example it may be used to automatically reduce the price which will be charged for bread which is more than about one day old when the identifier is scanned. As has been already noted, there are other forms of the invention which may also be used to provide some form of lapsed time indication.

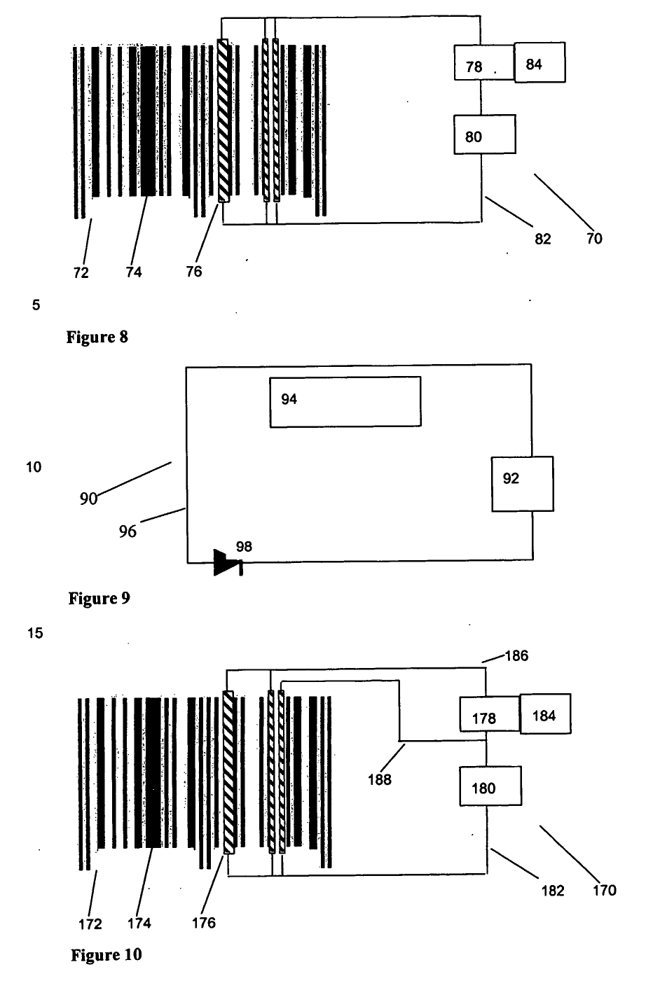

FIG. 9 shows a form of the invention in which an external source of electric power may be used to cause a change in binary state of a colour changing material. An identifier 90 comprises a code pattern 92 having parts formed form permanent materials and other parts of colour-changing materials similar to the code pattern 72 described with reference to FIG. 8. It also has an antenna 94, which may be formed by a printing method, capable of generating an electrical potential when placed in a suitable electromagnetic field. Conductive elements 96 are provided to provide an electric circuit between the code pattern 92 and the antenna 94. Any electric current induced to flow around the electric circuit as a result of the effect of the electromagnetic field on the antenna 94 will tend to be bi-directional. For some applications it will be desirable to incorporate a diode 98 into the electrical circuit so that the electric current flow is substantially uni-directional. If a diode is used electrically alignable bi-chromic pigment particles (such as E-ink) may be used as the colour change material. An identification device of this type may be used to indicate whether an item with which the identification device is associated has been exposed to electro-magnetic radiation, for example whether it has passed through an X-ray scanning machine for a security check.

Possible applications of identification devices according to the invention which are included in electric circuits include various means of determining whether a package, container or similar item has been opened or tampered with. In such applications the conductive elements 82 or 96 in FIGS. 8 and 9 respectively could be arranged in such a manner that opening or other tampering with the package or container would tend to cause a disturbance to the conductive elements such that there ceases to be an electrically conductive circuit. It will be apparent that such an application could employ a power source as in FIG. 8 in which case a change of scanned value of the code would indicate that disturbance of the conductive elements has occurred or that sufficient time has passed that the electrical potential of the power source has fallen below the value required to maintain the colour changing material at a particular binary value. Alternatively the form of the invention shown in FIG. 9 could be employed in which case the identifier could be exposed to suitable electromagnetic radiation prior to or during scanning and the scanned value of the code would indicate whether disturbance of the conductive elements has occurred.

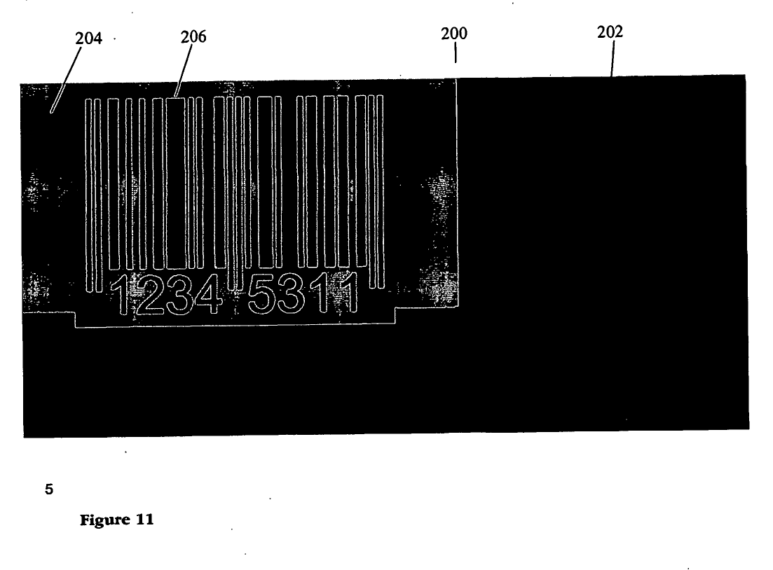

In many of the cases where the identifier requires continuous power, for example the variant of the arrangement shown in FIG. 8 wherein the switch 78 is normally closed it is possible to organise the electrical circuit will result in different scanned values of the code depending on whether the sensor has detected a stimulus and caused the switch to open or the electrical potential of the power supply has fallen below a critical value. The identification device shown in FIG. 10 is similar to that shown in FIG. 8 and components shown in FIG. 10 which serve substantially the same function as corresponding components in FIG. 8 have been allocated reference numbers which are 100 higher than those allocated to components in FIG. 8. It will be noted that different bars of colour changing material 176 form part of different electrically conductive circuits and are connected to either switchable electrically conductive elements 186 or to continuous electrically conductive elements 188. Thus those of the code bar(s) formed of colour changing material which are connected to the continuous electrically conductive elements 188 will remain in their electrically activated state unless the electrical potential of the power supply 180 falls below a critical value or he electric circuit becomes damaged. The code bar(s) formed of colour changing material which are connected to the switchable electrically conductive elements 186 will remain in their electrically activated state unless the sensor 184 detects a stimulus and causes the switch 178 to open, or the electrical potential of the power supply falls below a critical value, or the electric circuit becomes damaged. Thus the scanned value of the code will be different depending on whether the power supply 180 is still active and the switch 178 is open, or whether the electrical potential of the power supply has fallen below a critical value.

It will be apparent that by extension of the forms of the invention described above, an identifier may be made in which many or all of the components of the code are formed from one or more types of colour changing material and a multitude of electrical circuits are provided such that many or all of the components of the code are capable of being changed between the foreground and the background colours.

In some applications several different coded values may be included in one identification device. For example a shipping tag may include separate bar codes which provide information about the supplier location, the shipping address, the type of goods being shipped (e.g. parts number(s)) and the quantity of goods. Typically none of these codes would be changed after they are placed on the shipping tag. According to the invention one or more additional codes having values which are capable of changing in response to stimuli may be placed on the same shipping tag. The value of the code may be changed during shipping either automatically e.g. to indicate that the shipping tag has been exposed to adverse temperature or humidity, or by a deliberately applied stimulus e.g to denote a shipping route or time of delivery.

FIG. 10 shows an identification device formed from a dark coloured surface 202 (which may be unbleached paper or paper-board) on which a region of light colour ink 204 is printed such that a bar code 206 is formed as a result of the dark coloured surface 202 showing through gaps in the light coloured ink 204.

As will be apparent from the description and examples, where there is reference to a material or substance changing colour, the reference is to whether such a change would be perceptible to a human observer or to a reading machine or scanner. Therefore reference to change of colour is not restricted to change of hue but also encompasses changes in intensity or saturation provided that the human observer, reading machine or scanner can discern the change. It will further be apparent that one or more of the colours exhibited by a colour changing material may not been in the visible spectrum.

The words ‘substance’ and ‘material’ and forms of these words used in this description and in the claims are used synonymously. The use of either word refers to that of which a thing consists. In particular, where the context permits it refers to that from which the visible portion of the identifier consists.

The word ‘visible’ and forms of the word ‘visible’ as used in this description and in the claims refers to that which is capable of being perceptible to the human eye or to a machine which is capable of perceiving electromagnetic radiation.

The word ‘colour’ and forms of the word ‘colour’ as used in this description and in the claims encompasses bands of electromagnetic radiation outside of the spectrum which is visible to the human eye, and includes (but is not limited to) ultra-violet and infra-red radiation, but which is within the range which is detectable by a machine which is capable of perceiving electro-magnetic radiation.

The word ‘permanent’ and forms of the word ‘permanent’ as used in the description and the claims refer to a state which endures after a stimulus has been removed for a period of time sufficient for the application and/or purpose for which the identifier is being used.

The word ‘comprising’ and forms of the word ‘comprising’ as used in this description and in the claims do not limit the invention claimed to exclude any variants or additions.

Modifications and improvements to the invention will be readily apparent to those skilled in the art. Such modifications and improvements are intended to be within the scope of this invention.

1. An identifier comprising at least two machine readable components wherein at least one of said components is capable of being changed from an original value to a modified value in response to a stimulus.

2. An identifier according to claim 1 wherein at least some of the machine readable components comprise of elements having binary values.

3. An identifier according to any one of claims 1 or 2 wherein the identifier includes one or more graphic symbols and/or characters.

4. An identifier according to claim 3 wherein one or more graphic symbols and/or characters are alpha-numeric characters.

5. An identifier according to claim 1 wherein the identifier includes a bar code or pictographic code.

6. An identifier according to claim 5 wherein the bar code is a 1-dimensional bar code or pictographic code.

7. An identifier according to claim 5 wherein the bar code is a 2-dimensional bar code or pictographic code.

8. An identifier according to claim 5 wherein the bar code is a 3-dimensional bar code or pictographic code.

9. An identifier according to any one of claims 1 or 2 wherein the identifier includes at least one component capable of being read by a human which changes from an original form capable of being read by a human to a modified form capable of being read by a human in response to the stimulus.

10. An identifier according to claim 1 wherein the stimulus is a change in temperature.

11. An identifier according to claim 1 wherein the stimulus is a change in pressure.

12. An identifier according to claim 1 wherein the stimulus is a change in electric current.

13. An identifier according to claim 1 wherein the stimulus is a change in electromagnetic field.

14. An identifier according to claim 1 wherein the stimulus is a change in light (level, accumulative, wavelength).

15. An identifier according to claim 1 wherein the stimulus is a change in Chemical composition.

16. An identifier according to claim 1 wherein the stimulus is exposure to certain gases or vapours.

17. An identifier according to clam 1 wherein the stimulus is exposure to certain liquids, emulsions or slurries.

18. An identifier according to claim 1 wherein the stimulus is exposure to certain solids.

19. An identifier according to claim 1 wherein the stimulus is a change in time or an indirect consequence of a change in time.

20. An identifier according to claims 5 wherein at least some of the components may be used to represent digits.

21. An identifier according to claim 20 wherein at least one of the digits is a check digit.

22. An identifier according to claim 21 wherein the check digit does not change in response to the stimulus and its value is incorrect after the identifier has responded to the stimulus.

23. An identifier according to claim 21 wherein the check digit does not change in response to the stimulus and its value is correct after the identifier has responded to the stimulus.

24. An identifier according to claim 21 wherein the check digit changes in response to the stimulus such that its value is incorrect after the identifier has been exposed to the stimulus.

25. An identifier according to claim 21 wherein the check digit changes in response to the stimulus such that its value is correct after the identifier has responded to the stimulus.

26. An identifier according to claim 1 wherein the identifier includes a power source and an electrical circuit.

27. An identifier according to claim 26 wherein the power source includes at least one of a primary electric cell, a secondary electric cell, a photovoltaic device, a piezo-electric device or a capacitor.

28. An identifier according to claim 1, including a power antenna and an electrical circuit.

29. An identifier according to claim 26 wherein at least part of the power source is formed by printing.

30. An identifier according to claim 28 wherein at least part of the power antenna is formed by printing.

31. A package having an identifier according to any one of claims 26 to 30 wherein the electrical circuit is placed such that it will tend to be disturbed if the package is opened or tampered with.

32. An identifier formed by applying a light coloured material over a dark coloured surface such that gaps in the light coloured material form a machine readable code.

33. An identifier according to claim 32 which is capable to being changed from an original value to a modified value in response to a stimulus.

34. An identifier comprising at least two machine readable components wherein at least one of the said components is capable of being changed from one colour to another colour in response to a stimulus.

35. An identifier comprising a bar code or pictographic code having at least two machine readable components wherein at least one of the said components is capable of being changed from an original value to a modified value in response to a stimulus wherein both the original value and the modified value are machine readable.

36. (canceled)

37. A label or tag including an identifier according to claim 1.

38. A container having an identifier according to claim 1.
